(19) United States
(12) Patent Application Publication
(10) Pub. No.: US 2025/0279231 A1
(43) Pub. Date: Sep. 4, 2025

(54) SUPERCONDUCTING MAGNET DEVICE

(71) Applicant: SUMITOMO HEAVY INDUSTRIES, LTD., Tokyo (JP)

(72) Inventor: Yuta EBARA, Yokosuka-shi (JP)

(21) Appl. No.: 19/211,146

(22) Filed: May 17, 2025

Related U.S. Application Data
(63) Continuation of application No. PCT/JP2023/036218, filed on Oct. 4, 2023.

(30) Foreign Application Priority Data
Dec. 14, 2022 (JP) 2022-199653

(51) Int. Cl. H01F 6/04; H01F 6/06

(52) U.S. Cl. CPC H01F 6/04; H01F 6/06

(57) ABSTRACT

The present invention relates to a superconducting magnet device. Specifically, the superconducting magnet device includes: a superconducting coil; a cryocooler that cools the superconducting coil; and a heat transfer member that thermally couples the superconducting coil to the cryocooler and is operable as a secondary coil electromagnetically coupled to the superconducting coil.

### CROSS-REFERENCE TO RELATED APPLICATIONS

This is a bypass continuation of International PCT Application No. PCT/JP2023/036218, filed on Oct. 4, 2023, which claims priority to Japanese Patent Application No. 2022-199653, filed on Dec. 14, 2022, which are incorporated by reference herein in their entirety.

### BACKGROUND

### Technical Field

A certain embodiment of the present invention relates to a superconducting magnet device.

### Description of Related Art

An undesirable phenomenon that may occur during an operation of a superconducting magnet device is thermal runaway (quench) of a superconducting coil. When a quench occurs, the superconducting coil transitions from superconductivity to normal conductivity, and resistance is generated inside the coil. A large current flowing through the coil in the superconducting state can cause a large amount of Joule heat. There may also be a voltage rise in the coil and a resulting discharge. In addition, an imbalance of a transient current when the quench occurs may cause a large electromagnetic force to act on the superconducting coil. An eddy current may also be generated in a conductor disposed in the vicinity of the coil, causing an electromagnetic force to act. The heat, discharge, and electromagnetic forces that can be generated in this way may damage the superconducting coil and surrounding structures and devices. Therefore, it has been proposed to provide an induction coil near the superconducting coil. When a quench occurs, energy can be recovered from the superconducting coil to the induction coil through electromagnetic induction, allowing the energy held by the superconducting coil to be released.

### SUMMARY

According to an embodiment of the present invention, there is provided a superconducting magnet device including: a superconducting coil; a cryocooler that cools the superconducting coil; and a heat transfer member that thermally couples the superconducting coil to the cryocooler and is operable as a secondary coil electromagnetically coupled to the superconducting coil.

### BRIEF DESCRIPTION OF THE DRAWINGS

FIG. 1 is a diagram schematically showing a superconducting magnet device according to an embodiment.

FIG. 2 is a diagram schematically illustrating an energy extraction mechanism according to the embodiment.

FIGS. 3A and 3B are graphs schematically showing energy consumed by the energy extraction mechanism according to the embodiment.

FIG. 4 is a top view schematically showing a superconducting coil and a heat transfer member according to the embodiment.

### DETAILED DESCRIPTION

In the above-described configuration, since the induction coil is newly installed, an installation space for the induction coil is required around the superconducting coil. Alternatively, in a case where the induction coil is to be included in an existing space of the superconducting coil, a space occupancy ratio of the superconducting coil may be restricted by the amount of the induction coil added.

It is desirable to extract energy from a superconducting coil while suppressing spatial restrictions on the superconducting coil.

Hereinafter, an embodiment for carrying out the present invention will be described in detail with reference to the drawings. In the description and drawings, identical or equivalent components, members, and processing are denoted by the same reference numerals, and overlapping description is omitted as appropriate. The scale or shape of each part that is shown in the drawings is conveniently set for ease of description and is not limitedly interpreted unless otherwise specified. The embodiment is merely an example and does not limit the scope of the present invention in any way. All characteristics and combinations to be described in the embodiment are not necessarily essential to the invention.

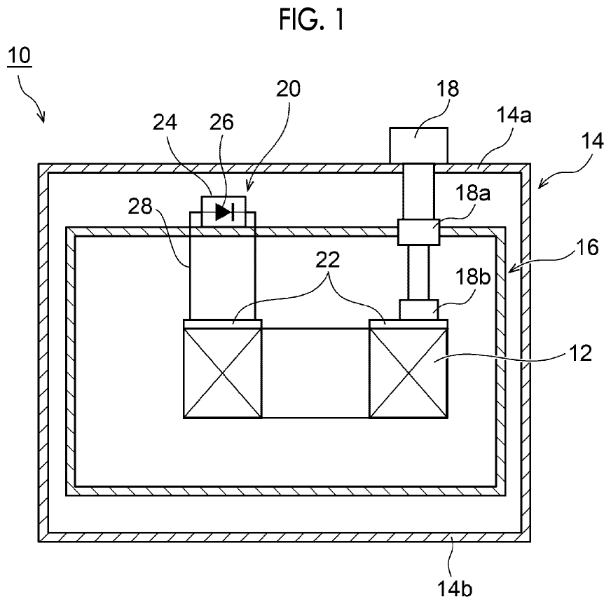

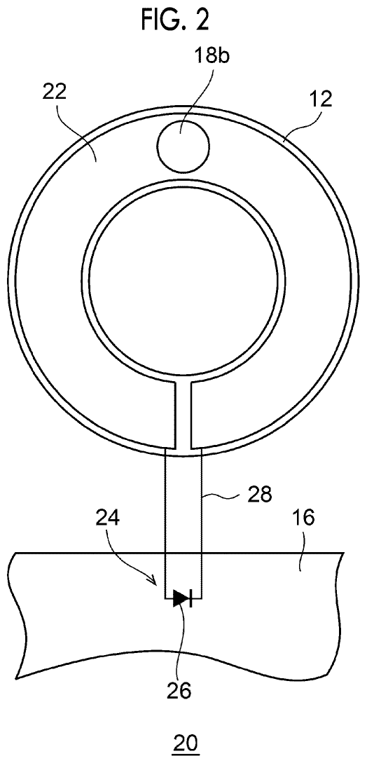

FIG. 1 is a diagram schematically showing a superconducting magnet device according to an embodiment. FIG. 2 is a diagram schematically showing an energy extraction mechanism according to the embodiment. The energy extraction mechanism shown in FIG. 2 can be applied to the superconducting magnet device shown in FIG. 1 as will be described later.

A superconducting magnet device 10 can be mounted on a high-magnetic field utilization device as a magnetic field source of, for example, a single crystal pulling device, a nuclear magnetic resonance (NMR) system, a magnetic resonance imaging (MRI) system, an accelerator such as a cyclotron, a high energy physical system such as a nuclear fusion system, or other high-magnetic field utilization devices (not shown) and can generate a high magnetic field required for the device.

The superconducting magnet device 10 includes a superconducting coil 12, a vacuum vessel 14, a heat shield 16, and an energy extraction mechanism 20.

The superconducting coil 12 is disposed in the vacuum vessel 14, and is configured to generate a strong magnetic field by being energized in a state of being cooled to a cryogenic temperature equal to or lower than a superconducting transition temperature. The superconducting coil 12 may be a known superconducting coil (for example, a so-called low-temperature superconducting coil). The superconducting coil 12 may be supplied with power from an external power source (not shown) disposed outside the vacuum vessel 14.

The superconducting coil 12 is thermally coupled to a cryocooler 18, for example, a two-stage Gifford-McMahon (GM) cryocooler or other types of cryocoolers installed in the vacuum vessel 14, and is used in a state of being cooled to a cryogenic temperature equal to or lower than a superconducting transition temperature. In this embodiment, the superconducting magnet device 10 is configured as a so-called conduction-cooled type in which the superconducting coil 12 is directly cooled by the cryocooler 18, instead of an immersion-cooled type in which the superconducting coil 12 is immersed in a cryogenic liquid refrigerant such as liquid helium. The superconducting magnet device 10 may be of an immersion-cooled type.

In FIG. 1, as an example, one cryocooler 18 is shown. However, for example, as in a case where the superconducting coil 12 is large, the superconducting magnet device 10 may include a plurality of cryocoolers 18 that cool one superconducting coil 12.

The vacuum vessel 14 is an adiabatic vacuum vessel that provides a cryogenic vacuum environment suitable for bringing the superconducting coil 12 into a superconducting state, and is also called a cryostat. Typically, the vacuum vessel 14 has a columnar shape or a cylindrical shape with a hollow portion at a central portion thereof. Therefore, the vacuum vessel 14 includes a substantially flat circular or annular top plate 14a and bottom plate 14b, and a cylindrical side wall (cylindrical outer peripheral wall, or coaxially disposed cylindrical outer peripheral wall and inner peripheral wall) connecting the top plate 14a and the bottom plate 14b. The cryocooler 18 may be installed on the top plate 14a of the vacuum vessel 14. The vacuum vessel 14 is formed of, for example, a metal material such as stainless steel or other suitable high-strength materials to withstand an ambient pressure (for example, atmospheric pressure).

The heat shield 16 is disposed to surround the superconducting coil 12 within the vacuum vessel 14. The heat shield 16 is formed of, for example, a metal material such as copper or other materials having high thermal conductivity. The heat shield 16 is directly attached to a first cooling stage 18a of the cryocooler 18 and is thermally coupled to the first cooling stage 18a. Alternatively, the heat shield 16 may be attached to the first cooling stage 18a via a heat transfer member having flexibility or rigidity. During an operation of the superconducting magnet device 10, the heat shield 16 is cooled to a first cooling temperature, for example, 30 K to 50 K, by the first cooling stage 18a. The heat shield 16 can thermally protect low-temperature sections such as the second cooling stage 18b of the cryocooler 18 and the superconducting coil 12, which are disposed inside the heat shield 16 and are cooled to a lower temperature than the heat shield 16, from radiant heat from the vacuum vessel 14.

The superconducting coil 12 is thermally coupled to the second cooling stage 18b via a heat transfer member 22. The heat transfer member 22 is formed of a metal material such as copper or other materials having high thermal conductivity, and connects the superconducting coil 12 to the second cooling stage 18b. The heat transfer member 22 may be a rigid member that is directly fixed to the second cooling stage 18b and rigidly connects the superconducting coil 12 and the second cooling stage 18b. Alternatively, an additional heat transfer member that connects the heat transfer member 22 to the second cooling stage 18b may be provided. This additional heat transfer member may be a rigid member, or may have flexibility and connect the superconducting coil 12 and the second cooling stage 18b to allow relative displacement therebetween. During the operation of the superconducting magnet device 10, the superconducting coil 12 is cooled to a second cooling temperature lower than the first cooling temperature, for example, 3 K to 20 K (for example, about 4 K) by the second cooling stage 18b.

The heat transfer member 22 is operable as a secondary coil electromagnetically coupled to the superconducting coil 12. As an example, the heat transfer member 22 includes a C-shaped heat transfer plate attached to an upper end surface of the superconducting coil 12 as shown in FIGS. 1 and 2. The heat transfer plate is in physical contact with the superconducting coil 12 over an entire circumference of the superconducting coil 12 in order to ensure good thermal contact with the superconducting coil 12. However, both ends of the C-shape of the heat transfer plate are adjacent to each other with a slight gap therebetween, as can be seen from FIG. 2. Therefore, the heat transfer member 22 can function as a coil having the number of turns of 1. When the magnetic field generated by the superconducting coil 12 fluctuates, a current that circulates along a circumferential direction of the superconducting coil 12 from one end to the other end of the C-shape is induced in the heat transfer member 22 by electromagnetic induction.

In this example, the heat transfer member 22 is attached to the upper end surface of the superconducting coil 12, but may be attached to a lower end surface of the superconducting coil 12. The C-shaped heat transfer plate attached to the lower end surface of the superconducting coil 12 may operate as a secondary coil electromagnetically coupled to the superconducting coil 12.

Since the heat transfer member 22 is adjacent to and in contact with the superconducting coil 12, a coupling coefficient between the heat transfer member 22 and the superconducting coil 12 serving as the secondary coil can be high. For example, the coupling coefficient is expected to be about 0.95. In addition, the heat transfer member 22 is cooled to a cryogenic temperature similarly to the superconducting coil 12. Electrical conductivity of the metal material (for example, copper) forming the heat transfer member 22 is significantly increased by cryogenic cooling. Both the increase in the coupling coefficient and the increase in the electrical conductivity are factors that improve energy extraction efficiency by the secondary coil. Therefore, by installing the heat transfer member 22 serving as the secondary coil on the superconducting coil 12, the energy extraction efficiency of the energy extraction mechanism 20 can be improved.

In addition, in an existing superconducting magnet device 10, a heat transfer member may be attached to an end surface of the superconducting coil 12. However, in such an existing design, a plurality of divided heat transfer pieces are prepared to prevent or reduce eddy currents circulating in the circumferential direction of the superconducting coil 12, and the heat transfer pieces are arranged with a gap therebetween in the circumferential direction of the superconducting coil 12. For example, two semicircular heat transfer pieces may be attached to the end surface of the superconducting coil 12 so as not to come into contact with each other.

Unlike such an existing split type heat transfer member, in the present embodiment, an induced current that circulates in the heat transfer member 22 is actively utilized to extract energy from the superconducting coil 12 as described later. Therefore, the heat transfer member 22 has a shape that can operate as a secondary coil, for example, a C-shape extending over the entire circumference of the superconducting coil 12 as described above.

In addition to the heat transfer member 22 operating as the secondary coil, the energy extraction mechanism 20 includes a Joule heat generating element 24 connected between both ends of the heat transfer member 22. The Joule heat generating element 24 includes a resistor and can generate heat by being energized. In this embodiment, the Joule heat generating element 24 includes a diode 26 as an example.

The Joule heat generating element 24 may include a general linear (that is, Ohmic) resistive element, or may include a non-linear resistor. The non-linear resistor may have non-linear characteristics in which a resistance value is high when a voltage applied to the non-linear resistor is low and the resistance value is low when the voltage applied to the non-linear resistor is high (the non-linear resistor may have a first resistance value when the voltage applied to the non-linear resistor is a first value and may have a second resistance value smaller than the first resistance value when the voltage applied to the non-linear resistor is a second value greater than the first value).

The non-linear resistor may be, for example, a rectifying element such as a diode or a thyristor. Alternatively, the non-linear resistor may be a varistor. The Joule heat generating element 24 may include both a linear resistor and a non-linear resistor, and for example, the linear resistor and the non-linear resistor may be connected in series.

The heat transfer member 22 and the Joule heat generating element 24 are connected to each other by an electric wire 28. The electric wire 28 may be formed of a metal material such as copper or other conductive materials. Alternatively, the electric wire 28 may include a high-temperature superconducting current lead. The high-temperature superconducting current lead may be formed of, for example, a copper oxide superconductor or other high-temperature superconducting materials. The material of such a high-temperature superconducting current lead has heat insulating properties. Therefore, compared to a case where the electric wire 28 is made of metal, it is possible to reduce heat that can be transferred from the Joule heat generating element 24 to the heat transfer member 22 through the electric wire 28 as a heat transfer path. This can reduce a heat load on the second cooling stage 18b of the cryocooler 18, and can lead to better cooling of the heat transfer member 22 and the superconducting coil 12.

The Joule heat generating element 24 may be cooled by the cryocooler 18. Accordingly, the heat generated by the Joule heat generating element 24 can be efficiently removed. In this case, the Joule heat generating element 24 may be thermally coupled to the first cooling stage 18a of the cryocooler 18, and may be installed in the heat shield 16 for that purpose. This is because a cooling capacity of a first stage of the cryocooler 18 is usually larger than (for example, several tens of times) a cooling capacity of a second stage, and there is a relatively large margin. In a case where circumstances permit, the Joule heat generating element 24 may be thermally coupled to the second cooling stage 18b of the cryocooler 18 and cooled by the second cooling stage 18b.

In general, when a quench or a sign of a quench is detected in the superconducting coil 12, the operation of the superconducting magnet device 10 is stopped, and the superconducting coil 12 is demagnetized. The magnetic field generated by the superconducting coil 12 is rapidly decreased from a desired high magnetic field to zero. In this case, a current is induced in the heat transfer member 22 serving as the secondary coil by electromagnetic induction. The current flows from the heat transfer member 22 to the Joule heat generating element 24 via the electric wire 28, causing the Joule heat generating element 24 to generate heat. In this way, the electromagnetic energy stored in the superconducting coil 12 is electromagnetically extracted by the heat transfer member 22 and is converted into heat by the Joule heat generating element 24. The heat is removed by cooling with the cryocooler 18.

In this way, at least a portion of the energy of the superconducting coil 12 can be consumed by the energy extraction mechanism 20. By reducing the energy of the superconducting coil 12, it is possible to prevent or reduce a resulting damage to the superconducting coil and surroundings thereof that may arise as a result.

In addition, when a temperature rise of the superconducting coil 12 due to the quench is large, a time required for the recooling for restoration is extended, that is, a downtime of the superconducting magnet device 10 may increase. In this embodiment, the energy extraction mechanism 20 can extract energy from the superconducting coil 12, which is advantageous in that the temperature rise of the superconducting coil 12 can be suppressed, and the time required for restoration from a quench can be shortened.

In a previously proposed configuration in which a dedicated induction coil is newly installed near the superconducting coil 12, a space for installing the induction coil is required around the superconducting coil, or a space occupancy ratio of the superconducting coil is restricted by the amount of the induction coil added. Contrary to this, in this embodiment, the heat transfer member 22 that thermally couples the cryocooler 18 and the superconducting coil 12 is also used as the secondary coil. Advantageously, since a function of the secondary coil is added to the heat transfer member 22, no additional space is required. The installation space and the space occupation ratio of the superconducting coil 12 can be maintained. Therefore, according to the embodiment, it is possible to extract energy from the superconducting coil 12 while suppressing spatial restrictions on the superconducting coil 12.

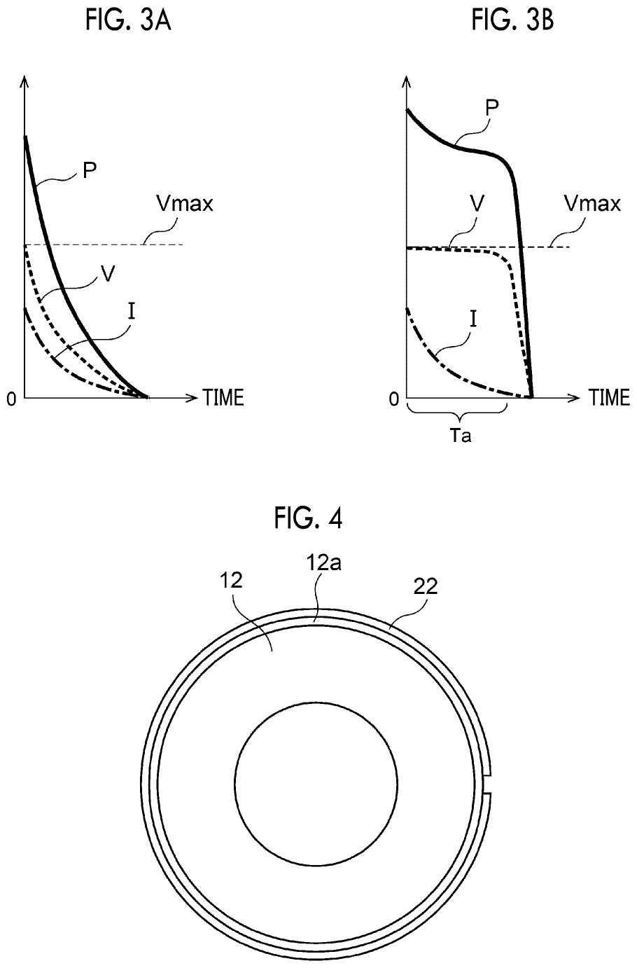

FIGS. 3A and 3B are graphs schematically showing the energy consumed by the energy extraction mechanism 20 according to the embodiment. FIG. 3A shows a case where the Joule heat generating element 24 has a linear resistive element, and FIG. 3B shows a case where the Joule heat generating element 24 has a non-linear resistive element (for example, the diode 26). FIGS. 3A and 3B show changes over time in a current I flowing through the Joule heat generating element 24 by electromagnetic induction when a quench occurs in the superconducting coil 12, a voltage V generated in the Joule heat generating element 24 by the current I, and energy P consumed in the Joule heat generating element 24 under the current I and the voltage V. A horizontal axis of the graph represents time, and the time when the quench occurs is set to time 0.

As shown in FIG. 3A, the current I becomes maximum when the quench occurs, and monotonously and rapidly (for example, exponentially) decreases with the passage of time. Since the Joule heat generating element 24 has a linear resistive element, the voltage Vis proportional to the current I. The voltage V, like the current I, becomes maximum when the quench occurs, and monotonously and rapidly decreases with the passage of time. Therefore, the consumed energy P also decreases monotonously and rapidly with the passage of time.

Here, the voltage V applied to the Joule heat generating element 24 must not exceed an upper limit voltage Vmax allowed by design (in other words, the Joule heat generating element 24 is designed such that the voltage V does not exceed the upper limit voltage Vmax).

In FIG. 3B as well, the current I becomes maximum when the quench occurs, and monotonously and rapidly (for example, exponentially) decreases with the passage of time. However, in a case where the Joule heat generating element 24 has the above-described nonlinearity, the voltage V is maintained at a large value close to the upper limit voltage Vmax until the current I decreases to a very small value from the quench generation time (time Ta in the drawing) (in other words, the Joule heat generating element 24 can be designed to maintain the voltage V near the upper limit voltage Vmax for a relatively long time by utilizing the nonlinearity). Therefore, the consumed energy P is maintained at a relatively high level over the time Ta.

In this way, in a case where the Joule heat generating element 24 has the non-linear resistive element, the total amount of the energy P consumed by the energy extraction mechanism 20 (that is, the time integral of the consumed energy P corresponding to the area of the graph shown in the figure) can be increased compared to a case of the linear resistive element, which is advantageous.

In addition, in a case where the Joule heat generating element 24 includes a rectifying element such as the diode 26, the rectifying element may be connected between both ends of the heat transfer member 22 so as to block a current in a first direction induced in the heat transfer member 22 when the magnetic field of the superconducting coil 12 increases and to allow a current in a second direction opposite to the first direction induced in the heat transfer member 22 when the magnetic field of the superconducting coil 12 decreases.

For example, a case where the superconducting coil 12 generates a magnetic field directed from the back to the front of the paper of FIG. 2 will be considered. When the superconducting coil 12 is excited, the magnetic field is increased. As a result, a current is induced in the heat transfer member 22 in a clockwise direction in FIG. 2 to cancel out this magnetic field (that is, a magnetic field in the opposite direction to the magnetic field of the superconducting coil 12 (a magnetic field directed from the front to the back of the paper) is generated). As shown in FIG. 2, the diode 26 is connected to the heat transfer member 22 in a direction of blocking the induced current.

Therefore, during excitation of the superconducting coil 12, the induced current that can flow to the energy extraction mechanism 20 is blocked by the diode 26. The energy input to the superconducting coil 12 for the excitation is not extracted from the energy extraction mechanism 20. Therefore, the superconducting coil 12 can be efficiently excited.

On the other hand, in a case where a quench occurs and the superconducting coil 12 is demagnetized, a clockwise current is induced in the heat transfer member 22 to cancel out the decrease in the magnetic field of the superconducting coil 12 (that is, to generate a magnetic field in the same direction as the magnetic field of the superconducting coil 12). This induced current flows in a forward direction in the diode 26 shown in FIG. 2. Therefore, the diode 26 allows the induced current. In this way, the energy extraction mechanism 20 can extract energy during the demagnetization of the superconducting coil 12. The above-described problem caused by the occurrence of a quench can be addressed.

The present invention has been described above based on the embodiment. It will be understood by those skilled in the art that the present invention is not limited to the above embodiments, various design changes can be made, various modification examples are possible, and such modification examples are also within the scope of the present invention. Various features described in relation to a certain embodiment are also applicable to other embodiments. A new embodiment generated through combination also has the effects of each of the combined embodiments.

In the above-described embodiment, a case where the heat transfer member 22 includes the C-shaped heat transfer plate attached to the upper end surface and/or the lower end surface of the superconducting coil 12 has been described as an example. However, the heat transfer member 22 may be disposed in another manner with respect to the superconducting coil 12. For example, as shown in FIG. 4, the heat transfer member 22 may include a C-shaped heat transfer plate attached to the outer peripheral surface of the superconducting coil 12. An outer frame 12a may be fixed to an outer peripheral surface of the superconducting coil 12 to suppress radially outward expansion of the superconducting coil 12 due to the electromagnetic force during the excitation, and the heat transfer member 22 may be attached to an outer surface of the outer frame 12a. Alternatively, the heat transfer member 22 may be attached to an inner peripheral surface of the superconducting coil 12. In this case, the heat transfer member 22 may be attached to a bobbin of the superconducting coil 12.

Although the present invention has been described using specific terms based on the embodiment, the embodiment only shows one aspect of the principle and application of the invention, and the embodiment allows for many modifications and changes in arrangement without departing from the concept of the invention as defined in the claims.

The present invention can be used in the field of superconducting magnet devices.

It should be understood that the invention is not limited to the above-described embodiment, but may be modified into various forms on the basis of the spirit of the invention. Additionally, the modifications are included in the scope of the invention.

What is claimed is:

1. A superconducting magnet device comprising:
a superconducting coil;
a cryocooler that cools the superconducting coil; and
a heat transfer member that thermally couples the superconducting coil to the cryocooler and is operable as a secondary coil electromagnetically coupled to the superconducting coil.

2. The superconducting magnet device according to claim 1,
wherein the superconducting coil is disposed in a vacuum vessel and is configured to generate a strong magnetic field by being energized in a state of being cooled to a cryogenic temperature equal to or lower than a superconducting transition temperature.

3. The superconducting magnet device according to claim 2,
wherein the vacuum vessel is an adiabatic vacuum vessel that provides a cryogenic vacuum environment suitable for bringing the superconducting coil into a superconducting state.

4. The superconducting magnet device according to claim 1,
wherein the heat transfer member includes a C-shaped heat transfer plate attached to an upper end surface, a lower end surface, an outer peripheral surface, or an inner peripheral surface of the superconducting coil.

5. The superconducting magnet device according to claim 4,
wherein the C-shaped heat transfer plate extends over an entire circumference of the superconducting coil, and
both ends of the C-shaped heat transfer plate are adjacent to each other with a gap therebetween.

6. The superconducting magnet device according to claim 1, further comprising:
a Joule heat generating element connected between both ends of the heat transfer member.

7. The superconducting magnet device according to claim 6,
wherein the Joule heat generating element includes a non-linear resistor.

8. The superconducting magnet device according to claim 7,
wherein the Joule heat generating element includes a linear resistor and the non-linear resistor connected in series.

9. The superconducting magnet device according to claim 8,
wherein the non-linear resistor has a non-linear characteristic in which a resistance value is high when a voltage applied to the non-linear resistor is low and the resistance value is low when the voltage applied to the non-linear resistor is high.

10. The superconducting magnet device according to claim 6,
wherein the Joule heat generating element includes a rectifying element, and
the rectifying element is connected between both ends of the heat transfer member so as to block a current in a first direction induced in the heat transfer member when a magnetic field of the superconducting coil increases and to allow a current in a second direction opposite to the first direction induced in the heat transfer member when the magnetic field of the superconducting coil decreases.

11. The superconducting magnet device according to claim 6,
wherein the cryocooler includes a first cooling stage that cools the Joule heat generating element and a second cooling stage that is cooled to a lower temperature than the first cooling stage and that cools the superconducting coil.
